(19) United States
(12) Patent Application Publication
(10) Pub. No.: US 2015/0138852 A1
(43) Pub. Date: May 21, 2015

(54) OVERLOAD LIMITATION IN PEAK POWER OPERATION

(71) Applicant: ABB Technology AG, Zuerich (CH)

(72) Inventors: Daniel SIEMASZKO, Genf (CH); John Eckerle, Basel (CH); Ata Douzdouzani, Birmenstorf (CH); Klaus Ruetten, Waldshut-Tiengen (DE)

(73) Assignee: ABB Technology AG, Zuerich (CH)

(21) Appl. No.: 14/608,602

(22) Filed: Jan. 29, 2015

Related U.S. Application Data
(63) Continuation of application No. PCT/EP2013/065155, filed on Jul. 18, 2013.

(30) Foreign Application Priority Data
Aug. 3, 2012 (EP) 12179165.1

(51) Int. Cl. H02M 1/32

(52) U.S. Cl. CPC H02M 1/32; H02M 2001/327
USPC 363/50

(57) ABSTRACT

An exemplary method for operating a converter to supply electrical power to a load includes controlling the converter for a provided overload time so that overload power is applied to the load, and controlling the converter for a provided resting time, so that resting power is applied to the load. The overload power is higher than a nominal power which corresponds to a steady-state operation limit of the converter, wherein the resting power is lower than the nominal power.

### RELATED APPLICATION(S)

This application claims priority under 35 U.S.C. §120 to International application PCT/EP2013/065155 filed on Jul. 18, 2013, designating the U.S., and claiming priority to European application 12179165.1 filed in Europe on Aug. 3, 2012. The content of each prior application is hereby incorporated by reference in its entirety.

### FIELD

The present disclosure relates to power converters, in particular to methods for operating power converters in a boost mode.

### BACKGROUND INFORMATION

Power converters are used to drive all kinds of electric power appliances, such as motors or the like. Such power converters are specified by their nominal power which indicates the amount of power to be supplied on a permanent basis without risking overheating or other damage to the used semiconductor devices therein, such as MOSFETs, thyristors, IGBTs and the like. The nominal power of a semiconductor device is usually defined as a power which, when supplied, causes the temperature within the semiconductor device to not exceed the temperature limit which is defined by the maximum allowable temperature for the semiconductor junction of the semiconductor device.

From document Murdock, D. A. et al., “Active Thermal Control of Power Electronic Modules”, IEEE Transactions on Industry Applications, Volume 42, No. 2, pp. 552-558, March-April 2006, it is known for power electronic modules to control the steady-state operation by thermal control for reaching maximum possible continuous operation.

Document WO 2009/033 999 A2 discloses a method wherein an actual temperature value of the semiconductor component is determined and, based on the actual temperature value and on a target temperature value, an actuator of a temperature control device, such as a motor cooling system, is actuated to adjust the actual temperature value. The actual temperature value is determined based on a temperature model.

Document JP 2011223678 A discloses a device having a protection unit. A calculation unit calculates the junction temperature of a switching element and the temperature of a proximity unit from a terminal resistance and a thermal time constant thereof. A correction unit corrects the junction temperature of the switching element based on the difference between the temperatures. A gate drive circuit or control unit is controlled such that the junction temperature of the corrected switching element does not exceed a temperature limitation value.

Document WO 2006/087618 A1 discloses a regulator having a temperature detecting unit to detect the temperature of an inverter. A limitation temperature setting unit sets the limitation temperature to a smooth temperature obtained by performing a smoothing process on the detected temperature when a change value of the detected temperature is below a preset value. An operating unit limits the operation of the inverter as an indication temperature increases.

Document SU 1 410 179 A discloses a method for operating a converter, wherein a signal proportional to a temperature of a p-n junction of a thyristor is compared to a fixed setting proportional to the maximum permissible temperature. If the temperature of the p-n junction exceeds the maximum permissible temperature, an actuator will trip the converter or limit the current through the thyristor.

Document U.S. Pat. No. 5,373,205 provides a control method defining a current limit, which is defaulted to a peak current, and in response to a temperature detected, which is in excess of a maximum allowable temperature, a nominal current limit is set. The current limit reset is reset to a peak current after it is detected that the temperature is below the maximum allowable temperature by a predetermined magnitude.

Document EP 0 971 573 B1 discloses a regulator for traction drives which is cooled by means of a cooling medium, wherein the amount of cooling medium for cooling the regulator is controlled according to a specified temperature.

Document EP 1 816 733 A2 discloses a method for operating a frequency converter with a periodically changing load characteristic. At the beginning of a new period the temperature of the key components, such as power semiconductors, of the frequency converter are predicted. In case an overheating of the key components is predicted, only a reduced load for the frequency converter is allowed so that the overheating can be prevented during the load cycle.

### SUMMARY

An exemplary method for operating a converter to supply electrical power to a load is disclosed, comprising: controlling the converter for a provided overload time period, so that overload power is applied to the load; and controlling the converter for a provided resting time period, so that resting power is applied to the load, wherein the overload power is higher than a nominal power, which corresponds to a steady-state operation limit of the converter, and the resting power is lower than the nominal power, wherein the converter is controlled in response to externally provided information, wherein the power applied to the load is limited as soon as the externally provided information causes the converter to provide overload power for more than a given maximum overload time period, and wherein after the maximum overload time period the power to be applied to the load is limited according to a limitation function which provides a limitation value that reduces an allowable power from the overload power to the nominal power according to predetermined time characteristics.

### BRIEF DESCRIPTION OF THE DRAWINGS

Exemplary embodiments of the present disclosure are described in more detail in conjunction with the accompanying drawings, in which:

FIG. 1 shows a system having a power converter to supply an electrical appliance with electrical energy in accordance with an exemplary embodiment of the present disclosure;

FIG. 2 shows a diagram illustrating the power output of the power converter of the system according to FIG. 1 and the resulting junction temperature of a semiconductor switch in the power converter in accordance with an exemplary embodiment of the present disclosure; and

FIG. 3 shows a diagram illustrating the power output of the power converter of the system according to FIG. 1, the power limitation as well as the resulting junction temperature of a semiconductor switching device of the power converter in accordance with an exemplary embodiment of the present disclosure.

### DETAILED DESCRIPTION

Exemplary embodiments of the present disclosure provide an overheating-protected operation for electrical appliances which have a power consumption exceeding the nominal power of the power converter.

According to an exemplary embodiment of the present disclosure, a method for operating a converter to supply electrical power to a load, including the steps of controlling the converter for a provided overload time period so that overload power is applied to the load, and controlling the converter for a provided resting time period so that resting power is applied to the load, wherein the overload power is higher than a nominal power which corresponds to a steady-state operation limit of the converter, wherein the resting power is lower than the nominal power, wherein the converter (3) is controlled in response to an externally provided information, wherein the power applied to the load (2) is limited as soon as the externally provided information causes the converter (3) to provide overload power for more than a given maximum overload time period, wherein after the maximum overload time period the power to be applied to the load (2) is limited according to a limitation function which provides a limitation value which reduces an allowable power from the overload power to the nominal power according to a predetermined time characteristics.

An exemplary embodiment of the present disclosure allows a power converter to be operated such that overload power exceeding a nominal power can be provided for a specific overload time period as long as the power converter is subsequently operated to supply a resting power which is below or equal to the nominal power during a specific resting time period. This operating scheme allows for the use of electrical appliances with a power converter even if the electrical appliances have a short-timed power consumption which goes beyond the nominal power of the power converter connected thereto. Hence, a power converter is allowed to be boosted over its nominal operation point and an overload operation for a specific overload time period is allowed, on the condition that there is a subsequent resting time period for the overall system, e.g., to cool down or to settle. The overload power operation may be designed for the overload time period following a profile of overloadability allowance as a function of time and overload power.

According to exemplary embodiments disclosed herein, the converter is controlled in response to an externally provided information, wherein the power applied to the load is limited as soon as the externally provided information causes the converter to provide overload power for more than a given maximum overload time period and after the maximum overload time period, the power to be applied to the load may be limited according to a limitation function which provides a limitation value which reduces the allowable power from the overload power to the nominal power according to predetermined time characteristics.

This method for operating a converter has the advantage that the converter can be operated in any overload power condition, which must not previously be known. The converter, thereby, can react to a previously unknown overload power condition.

Furthermore, the resting power and resting period may be set such that at least one parameter, in particular a temperature of the converter, returns to its initial value at the start of the overload period.

According to an exemplary embodiment of the present disclosure, the overload power and overload time period are set such that at least one parameter, in particular a temperature of the converter, does not exceed a limit during the overload time.

Furthermore, the resting time period may directly follow the time overload period.

Moreover, the overload time period and the resting time period may be periodically repeated.

The maximum overload time period may be a period in which a temperature in the converter reaches a predetermined maximum temperature limit.

Moreover, the predetermined time characteristics may define a linear or exponential slope from the overload power to the nominal power.

According to another exemplary embodiment of the present disclosure, an apparatus for operating a converter to supply electrical power to a load includes a control unit which is configured to control the converter for a provided overload time, so that overload power is applied to the load, and control the converter for a provided resting time, so that resting power is applied to the load, wherein the overload power is higher than a nominal power which corresponds to a steady-state operation limit of the converter, wherein the resting power is lower than the nominal power.

According to a further exemplary embodiment, a system includes a load, a converter for supplying electrical power to the load, and the above apparatus.

FIG. 1 shows a system having a power converter to supply an electrical appliance with electrical energy in accordance with an exemplary embodiment of the present disclosure. Namely, FIG. 1 shows a system 1 for providing electrical energy to a load (electrically driven unit) 2. The load 2 may be a part of a manufacturing facility and used to drive a tool part periodically. For instance, the load 2 may be a power drive or a similar load.

Electrical energy is provided to the load 2 by a power converter 3 which has included switching devices 31 to provide a predetermined amount of electrical power to the load 2. The switching devices 31 may be configured as power semiconductor devices, such as power MOSFETs, thyristors, IGBTs, IGCTs and the like. The switching devices may be arranged in a driver configuration such as a power inverter, half-bridge configuration, full bridge configuration or the like.

Due to the heat sensitivity of the switching devices, the power converter 3 has a limited temperature operating range whose upper limit is determined by the maximum p-n junction temperature of the semiconductor devices used therein. As exceeding the maximum allowable junction temperature may affect the operability and/or lifetime of the semiconductor switching device, the maximum allowable temperature should not be exceeded.

For the power converter 3 there is thus defined a nominal power which represents the power output of the power converter 3 on a continuous operation basis, wherein the nominal power indicates the maximum power output of the power converter 3 at which the junction temperature of the semiconductor devices approaches or arrives at the maximum allowable temperature under predefined environmental conditions.

The load 2 may be configured to consume power that exceeds the nominal power output of the power converter 3. The power consumption can occur in a non-continuous manner, e.g., periodically or intermittently.

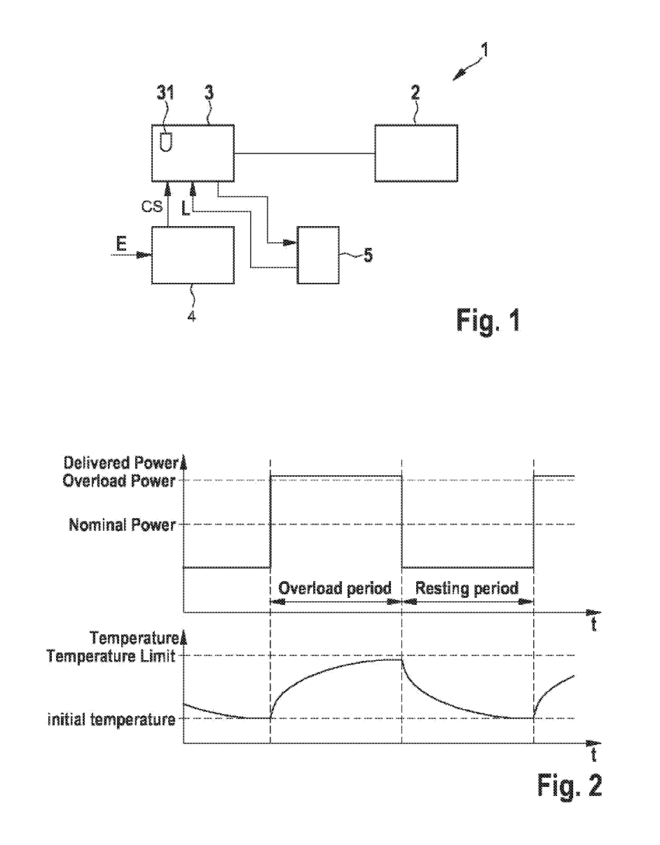

FIG. 2 shows a diagram illustrating the power output of the power converter of the system according to FIG. 1 and the resulting junction temperature of a semiconductor switch in the power converter in accordance with an exemplary embodiment of the present disclosure. As shown in FIG. 2, the electrical appliance 2 is allowed to consume overload power for a specific overload time period. According to an exemplary embodiment, the overload power can be, e.g. up to 40% above the nominal power which defines the steady-state operation limit while the overload time period can be set to a predetermined duration which may be fixedly set or which may be dependent on the amount of overload power requested by the load.

After the overload time period during which overload power is supplied to the load 2, the power output is reduced to a power level which is lower than the nominal power for a specific resting time period. The resting power and the resting time period may be adapted such that the semiconductor devices can cool down to a predetermined temperature which is lower than the maximum allowable temperature. In case of a periodic operation of supplying overload power and resting power, the resting period and resting power are adapted such that at the end of the resting period the junction temperature has arrived at an initial temperature from which temperature may increase when applying overload power during a next (subsequent) overload period.

A control unit 4 is provided which controls the power converter 3 depending on control signals CS. The control signals CS are generated according to a predefined scheme following an externally provided signal E, which may be provided by a process controller or the like. The externally provided signal E indicates the power at which the load 2 shall be operated.

Furthermore, a supervisor unit 5 is provided which permanently, regularly, or cyclically receives from the power converter 3 or the control unit 4, respectively, the amount of power being supplied to the load 2. Mainly, the supervisor unit 5 applies a power limitation by accordingly commanding the converter unit 3 in case overload power is applied to the load 2 for an overload time period which exceeds a predetermined overload period threshold. The limitation is performed by providing a limitation value L to the power converter 3, such that the power converter 3 limits its power output according to the limitation value L.

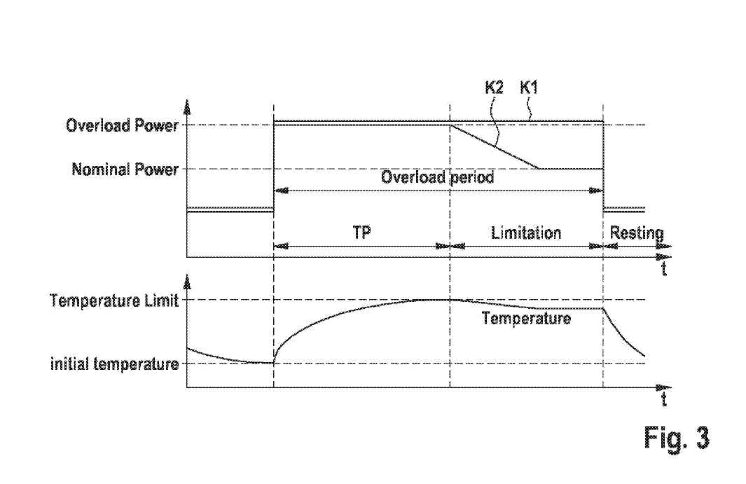

FIG. 3 shows a diagram illustrating the power output of the power converter of the system according to FIG. 1, the power limitation as well as the resulting junction temperature of a semiconductor switching device of the power converter in accordance with an exemplary embodiment of the present disclosure. As shown in the diagram of FIG. 3, the limitation will take its effect if the overload power is specified for more than the predetermined maximum overload time period TP, as indicated by curve K1 (specified power) in the diagram of FIG. 3. The maximum overload time period TP is defined by the period in which the junction temperature arrives at the temperature limit when starting from an initial temperature at the beginning of the overload time period for which the overload power shall be applied.

The limitation is made according to the limitation curve K2 (limitation function) which may provide a ramp down from overload power to nominal power after the maximum overload time period TP, so that the junction temperature may be kept at the temperature limit and is no longer increasing. The transition between providing the overload power to nominal power can be shaped as a linear slope or with exponential characteristics to limit the power supply of the load 2 back to nominal power. The gradient of the slope from the overload power level down to nominal power may be depending on the kind of load 2 attached, the amount of overload power, and the duration of the overload period or the like. A stepwise (sudden) reduction of the power applied to the load 2 should be avoided due to undesired effects such as reflections in the connecting lines, electromagnetic interferences and the like.

The power limitation can be performed by limiting the output current of the power converter 3, limiting the output voltage of the power converter 3, and/or by limiting (or reducing) the switching frequency of the power converter 3 or the like.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### REFERENCE LIST

1 System
2 Load
3 Power converter
4 Control unit
5 Supervisor unit
31 Semiconductor device

What is claimed is:

1. A method for operating a converter to supply electrical power to a load, comprising:
controlling the converter for a provided overload time period, so that overload power is applied to the load; and
controlling the converter for a provided resting time period, so that resting power is applied to the load,
wherein the overload power is higher than a nominal power, which corresponds to a steady-state operation limit of the converter, and the resting power is lower than the nominal power,
wherein the converter is controlled in response to externally provided information,
wherein the power applied to the load is limited as soon as the externally provided information causes the converter to provide overload power for more than a given maximum overload time period, and
wherein after the maximum overload time period the power to be applied to the load is limited according to a limitation function which provides a limitation value that reduces an allowable power from the overload power to the nominal power according to predetermined time characteristics.

2. The method according to claim 1, wherein the resting power and resting time period are set such that at least one parameter returns to an initial value at the start of the overload time period.

3. The method according to claim 1, wherein the overload power and overload time period are set such that at least one parameter does not exceed a limit during the overload time period.

4. The method according to claim 2, wherein the at least one parameter is a temperature of the converter.

5. The method according to claim 3, wherein the at least one parameter is a temperature of the converter.

6. The method according to claim 1, wherein the resting time period follows the overload period.

7. The method according to claim 1, wherein the resting time period directly follows the overload period.

8. The method according to claim 1, wherein the overload time period and the resting time period are periodically repeated.

9. The method according to claim 1, wherein the maximum overload time period is a period in which a temperature in the converter arrives at a predetermined maximum temperature limit.

10. The method according to claim 1, wherein the predetermined time characteristics defines a linear slope from the overload power to the nominal power.

11. The method according to claim 1, wherein the predetermined time characteristics defines an exponential slope from the overload power to the nominal power.
